(19) United States
(12) Patent Application Publication
(10) Pub. No.: US 2013/0147603 A1
(43) Pub. Date: Jun. 13, 2013

(54) Iris Cameras

(71) Applicants: Imad Malhas, Amman (JO); Andrew Holland, Aylesbury (GB)

(72) Inventors: Imad Malhas, Amman (JO); Andrew Holland, Aylesbury (GB)

(73) Assignee: IRISGUARD INC., George Town, (KY)

(21) Appl. No.: 13/355,428

(22) Filed: Jan. 20, 2012

(30) Foreign Application Priority Data
Dec. 13, 2011 (GB) 1121411

(51) Int. Cl. G06F 7/04

(52) U.S. Cl. 340/5.83

(57) ABSTRACT

The present invention relates to a method for authenticating a transaction using a biometric identifier and a portable data store. The method comprises: generating a first bit pattern of a user's iris from a captured image of the user's iris; accessing a user profile stored on the portable data store, the user profile comprising a pre-stored second bit pattern of an authentic user's iris; comparing the first and second bit patterns; and generating an authentication signal to authenticate the transaction, when the first and second bit patterns are equivalent. In addition, the present invention relates to apparatus for carrying out the present method.

### CROSS REFERENCE TO RELATED APPLICATIONS

This application claims the right of priority under 35 U.S.C. §119 to GB application serial no. 1121411, filed Dec. 13, 2011, which is incorporated by reference in its entirety.

### BACKGROUND

1. Field of Art

The present invention concerns improvements relating to iris cameras and more particularly, though not exclusively to the manner in which they interact with users and electronic devices for communicating captured data.

2. Description of Art

Iris Recognition Technology has been around since the mid 1980's and with the evolution of imaging and optical technology, the advancements, particularly in size and speed of capturing the biometric information have been dramatic. IrisGuard (the present applicant) has been one of the pioneers in enhancing this technology on all fronts. This comprises capture hardware, image processing/analysis and biometric algorithm generation to support its worldwide and mass transit projects in the UAE, Jordan and USA.

Currently known credit and/or debit card transactions often require that the user provide their personal identification number (PIN) to confirm a transaction. The introduction of the PIN is considered indicative that the genuine card holder is authorizing the requested transaction. However, the use of a PIN is associated with certain unwanted shortcomings. For example, it requires that the user memorizes the PIN. If the PIN is subsequently forgotten a new PIN must be reissued by the issuer. This often also requires issuing a new credit and/or debit card. One way in which users may mitigate for this problem is by recording the PIN. However, this creates a security risk and increases the likelihood that the recorded PIN may fall into the hands of a malicious user. For this reason all card issuers advise against recording a PIN. Furthermore, it is possible for a PIN to be observed by a third party while being entered into a terminal, which also compromises its security.

Many people currently have more than one credit and/or debit card each associated with a unique PIN. Accordingly, the burden on the user to remember the different PINs is increased. To mitigate for this, often users resort to using the same PIN for all their different credit and/or debit cards. As a consequence, if the PIN of one card is compromised, the security of all other cards is also compromised.

The ability for a human being to safely identify themselves uniquely, without repudiation is critical in the modern world, as cashless payment systems become ever more widespread. However, the growth in cashless payment systems has seen an associated growth in fraudulent transactions, due in part to the ease with which malevolent users can obtain the credit and/or debit card details of users.

Many countries have now adopted the EMV® (Europay, Mastercard and Visa) payment protocol (also referred to as ISO/IEC 7816-3, or more commonly known as ‘Chip and PIN’), wherein a user is required to enter their PIN at a point of sale to confirm a purchase. The correct entry of the PIN is deemed to validly indicate the user's authorization of the requested transaction. However, it is clear that EMV® suffers from the same security shortcomings that any payment system reliant on user PIN entry suffers from.

A Biometric trait is a trait that is unique to the biology of a specific human being. DNA and Iris Recognition Technology (IRT) are but two different examples of known biometrics. However, due to the difficulties in acquiring sufficient DNA samples, DNA biometrics are not considered practical for most applications, where a user's identity needs to be uniquely determined. In contrast, Iris Recognition Technology is far more practical, and is advantageously non-invasive.

The human eye forms during the fetal gestation period, as an extension of the brain. The iris, which is an involuntary muscle, is part of the eye, and comprises a random structure formed during chaotic morphogenesis. The genetic penetration in the formation of the iris is the color but the iris muscle is statically random and therefore provide an ideal means for uniquely identifying a living human being. It is also protected by the aqueous humor, and is therefore the only biometric trait that is classified as an internal organ.

Biometric identification systems which use the iris for identification purposes are generically referred to as Iris Recognition Technology (IRT). Such systems tend to capture an image of a user's iris—the biometric trait—which is subsequently compared with a previously stored iris biometric trait, to verify the user's identity. In practical implementations of IRT, speed and accuracy of verification is critical. One key area which affects the total time taken to verify a user's identity, is the round trip time it takes to communicate the captured biometric information to a central database, and to receive the verification response. The verification response confirms if the captured user iris information agrees with user information stored in the central database for a valid user identity. Accordingly, the size of the biometric trait information must be minimized to retain speed of identification. For this reason, a binary bit string, commonly referred to as a bit pattern is generated and forwarded to the central database for verification, in place of the captured iris image. To illustrate the advantage of this approach consider that two sets of iris bit patterns are less than 2K bytes in size, whereas a high-definition image of the iris will be many orders of magnitude larger, on the order of several megabytes, if not tens of megabytes.

It is an object of the present invention to overcome at least some of the above described issues, and in particular to provide a more secure means for carrying out financial transaction.

### SUMMARY

According to one aspect of the present invention there is provided a method of authenticating a transaction using a biometric identifier and a portable data store. The method comprises: generating a first bit pattern of a user's iris from a captured image of the user's iris; accessing a user profile stored on the portable data store, the user profile comprising a pre-stored second bit pattern of an authentic user's iris; comparing the first and second bit patterns; and generating an authentication signal to authenticate the transaction, when the first and second bit patterns are equivalent.

The method of the present invention provides an improved, more secure method for carrying out transactions, which is quick, and does not place any burden on the user, such as requiring the user to memorize a PIN or password. It enables the identity of a user requesting a transaction to be verified quickly by cross-referencing the identity of the user requesting the subject transaction with the identity of the authorized data store user. This minimizes the risk of a fraudulent transaction occurring, since a positive comparison result is indicative of the identity of the user requesting the transaction corresponding with the identity of the authorized data store user.

The security of a biometric trait such as an iris print pattern is dependent on the confidentiality of the algorithm used to generate the bit pattern from the captured iris image. Without knowing the specific conversion algorithm employed, it is extremely difficult and statistically unlikely that a fraudulent user is able to generate a fraudulent iris bit pattern for use in deceiving a system employing the present method into generating a false positive comparison result.

The generating step may comprise capturing an image of a user's iris and generating the first bit pattern from the captured image. The accessing step may comprise obtaining the user profile from the portable data store.

Optionally, and where the user profile is encrypted, the accessing step may comprise decrypting the user profile.

In certain embodiments, the accessing step is carried out on a portable data store terminal.

The term ‘transaction’ as used herein covers all forms of transactions which require authentication of the user using a portable data store. In particular, purchasing transactions such as credit card transactions are covered, as well as ‘access’ transactions enabling authentication of the user to allow them to pass through a gate, door, or turnstile.

In certain embodiments, the comparing step and the authentication signal generating step are carried out local to the portable data store terminal. One advantage of this embodiment is that confidential biometric information is not transmitted across potentially unsafe communication channels, which may be subject to eavesdropping. There are also significant speed advantages associated with carrying out local processing to validate a user identity, compared to remote verification, where an additional time latency is incurred due to the round trip time taken to forward the biometric data to a remote server for verification, and to receive the authentication signal.

Alternatively, the comparing step and the authentication signal generating step are carried out on the portable data store. This is advantageous where the fidelity of the data store terminal is not guaranteed, and ensures that confidential biometric data is not transferred to a potentially compromised terminal.

Alternatively, the comparing step and the authentication signal generating step are carried out remote to the portable data store terminal. Such as on a computer processor in operative communication with the portable data store terminal. Outsourcing the processing tasks to an operatively connected PC improves the simplicity and minimizes the cost of the hardware required to implement the present method.

In further alternative embodiments, the comparing step and the authentication signal generating step are carried out on a remotely located server in operative communication with the portable data store terminal.

In preferred embodiments, the portable data store terminal comprises a camera arranged to capture an image of a user's iris.

In alternative embodiments, the method further comprises generating a one-time password (OTP) in response to the generation of the authentication signal. This is particularly advantageous in applications requiring a one-time password, and ensures that the OTP is only generated for an authorized user.

According to a second aspect of the present invention, there is provided a data store authentication terminal, for authenticating a transaction using a biometric identifier and a portable data store. The terminal comprises: an iris pattern acquisition system for generating a first bit pattern of a user's iris from a captured image of the user's iris; a data store interface for accessing a user profile stored on the portable data store, the user profile including a pre-stored second bit pattern of an authentic user's iris; an authentication module configured to compare the first and second bit patterns, and generate an authorization signal to authenticate the transaction, when the first and second bit patterns are equivalent.

The present authentication terminal provides a self-contained device for carrying out the aforementioned method, and may be used at any point of sale, to complement and/or to replace conventional, known electronic point of sale terminals. Additionally, provisions of the present terminal enables the identity of the user to be verified quickly and locally at the terminal without having to connect to a remote device (e.g., backend server), and/or to search a pre-existing database of user biometric data. There is also an associated time advantage, in that the processing time required to compare two pieces of information provided in a request is far less than the time that would be required for searching for (looking up) a biometric trait from a remotely located database and then comparing its contents with that sent in one or more packets of data.

Preferably, the iris pattern acquisition system comprises an iris camera for capturing the image of the user's iris.

In alternative embodiments where the portable data store comprises an integrated circuit, the terminal's data store interface is arranged to power the integrated circuit, and the integrated circuit is configured to compare the first and second bit patterns and generate the authorization signal. This is advantageous since it maintains the confidentially of biometric information stored on the portable data store. Confidential biometric information is not transferred to the terminal for comparison with the first iris bit pattern. Only the result of the comparison is transmitted.

In alternative embodiments where the portable data store comprises a magnetic stripe, the data store interface is arranged to access the user profile stored in the magnetic stripe. In this way, the present terminal is compatible for use with known magnetic stripe cards.

In further alternative embodiments where the portable data store is a near field communication device, the terminal comprises a near field communication transceiver arranged to enable wireless data communication with the portable data store. In this way, the present terminal is compatible with near field communication enabled data store cards.

In embodiments where the user profile comprised in the data store is encrypted, the terminal is configured with a decryption module for decrypting the user profile. In this way, the terminal is able to read the user profile data. Preferably, the terminal comprises a decryption module meeting the certification standards EAL4+ Ready, FIPS 140-2 security level 3, SSL support, Microsoft CSP Minidriver compliant, PKCS#11, Microsoft MS-CAPI, and EMVCo.

In certain embodiments the terminal comprises data communication means for transmitting the authorization signal to a remote server to carry out a user requested transaction.

In alternative embodiments, the terminal comprises a one-time password generator configured to generate a one-time password (OTP) in response to the generation of the authorization signal. In this way, the terminal may be used as a secure device for generating OTPs. Since the OTP is only generated in response to the authorization signal, this ensures that the OTP is only issued where the identity of the authorized user has been verified.

According to a third aspect of the present invention, there is provided a data store authentication terminal, for authenticating a transaction using a biometric identifier and a portable data store. The terminal comprises: an imaging system for capturing an image of a user's iris; a data store interface for accessing a user profile stored on the portable data store; a transmitter configured to transmit the captured image of the user's iris or information derived therefrom, and the user profile to a remote device for comparison; a receiver for receiving an authorization signal representing a result of the comparison from the remote device; and a processor arranged to enable the transaction to be carried out in the event of a positive comparison outcome result. An advantage of this aspect of the present invention is that a simpler, lower-cost terminal may be used, since the processor-intensive task of generating the comparison outcome is outsourced to the remote device.

In certain embodiments the processor is arranged to generate a first iris bit pattern from the captured image, and the transmitter is configured to transmit the first iris bit pattern to the remote device. Since an iris bit pattern is significantly smaller in size than an image of an iris, it takes significantly less time to transmit an iris bit pattern to a remote device compared with an image. In addition, it also decreases the time taken by the remote device to carry out the comparison and generate the authorization signal.

In alternative embodiments, the user profile comprises a second iris bit pattern; the transmitter is configured to transmit the second iris bit pattern to the remote device; and the receiver is arranged to receive an authorization signal representing the result of the comparison between the first bit pattern and the second bit pattern.

In alternative embodiments, where the data store comprises an integrated circuit, the data store interface is arranged to power the integrated circuit, such that the processing power of the integrated circuit may be used to carry out specific tasks. In this way, the present terminal is compatible for use with integrated circuit cards.

Alternatively, where the portable data store comprises a magnetic stripe, the data store interface is arranged to access the user profile stored in the magnetic stripe. In this way, the present terminal is compatible for use with conventional magnetic stripe cards.

In further alternative embodiments, where the portable data store is a near filed communication device, the terminal comprises a near field communication transceiver arranged to enable wireless data communication with the data store. In this way, the present terminal may be configured for use with near field communication-enabled data stores.

In certain embodiments, where the user profile is encrypted, the terminal comprises means for decrypting the user profile, such that the user profile may be transferred to the remote device in unencrypted form. Preferably, the terminal comprises a decryption module meeting the certification standards EAL4+ Ready, FIPS 140-2 security level 3, SSL support, Microsoft CSP Minidriver compliant, PKCS#11, Microsoft MS-CAPI, and EMVCo.

Optionally, the terminal may be operatively connected to a personal computer (PC) via a shared data communication channel. In such embodiments, the transmitter is configured to transmit the captured iris image or information derived therefrom and the user profile to the PC for data comparison; and the receiver is arranged to receive the authorization signal generated by the PC. An advantage of such embodiments is that the processing power of an attached PC may be used to carry out the more processor intensive task of carrying out the comparison and generating the authentication signal. This helps to simplify the design of the terminal, in addition to minimizing manufacturing costs.

Alternatively, the terminal is operatively connected to a remote server via a shared data communication channel, and the transmitter is configured to transmit the captured iris image or information derived therefrom and the user profile to the remote server for data comparison. Additionally, the receiver is arranged to receive the authorization signal generated by the remote server. In this way, the comparison and signal authentication generation are outsourced to the remote server, which minimizes the processing requirements of the terminal, simplifies the construction of the terminal, and accordingly minimizes manufacturing costs.

The terminal may comprise a display for presenting the data comparison result to the user. The display improves the user experience and can advantageously be used to communicate process status updates to the user.

In certain embodiments the terminal may comprise a portable hand held terminal.

Alternatively, the terminal may comprise a mobile telephone.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 (FIG.) is a schematic diagram showing a system comprising a new iris authentication terminal according to an aspect of the present invention:

FIG. 2 is a schematic block diagram of an example of the iris authentication terminal of FIG. 1, configured to carry out local authentication;

FIG. 3 is a schematic block diagram of an alternative example of the iris authentication terminal of FIG. 1, configured to outsource authentication to a remote processor;

FIG. 4A is an illustration of the portable iris authentication terminal of FIGS. 2 and/or 3;

FIG. 4B is a longitudinal sectional view of the internal configuration of the portable iris authentication terminal of FIG. 4A;

FIG. 4C is a perspective longitudinal sectional view from above, of an alternative configuration of the portable iris authentication terminal of FIG. 4A comprising both a magnetic strip card reader and an NFC reader; and

FIG. 5 is a process flow chart of the method carried out by the iris authentication terminal of FIGS. 1 to 4.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Preferred embodiments will now be described with reference to the appended figures.

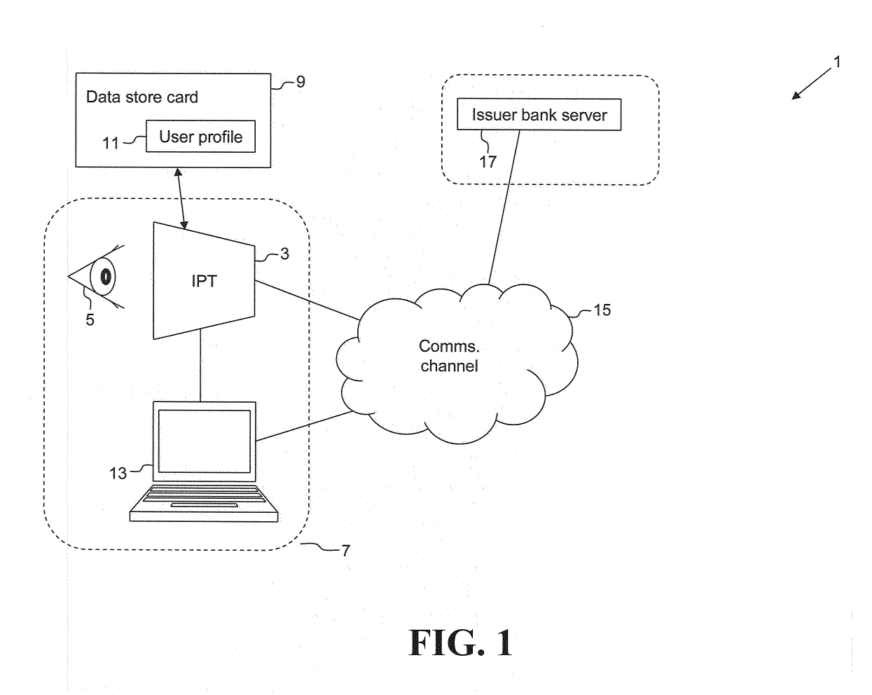

FIG. 1 illustrates a system 1 comprising the iris authentication terminal of the present invention. For the avoidance of any confusion, in the ensuing description the terminal will be referred to as an Iris Portable Terminal 3 (IPT). It is to be understood that while it is preferable for the terminal to be portable, this is not a necessary restriction, and alternative embodiments encompassing fixed terminals are envisaged and fall within the scope of the present invention.

The object of the IPT is to introduce a biometric identifier into a transaction involving a user's portable data store. Such data store devices may relate to credit cards, debit cards, loyalty cards, or any other device associated with a user profile, which may be used for carrying out a transaction, including but not limited to financial transactions. These data stores are typically permanent to the user and are issued by a transaction authority. They often include some stored secure information such as a PIN, which is used to confirm a user's identity. They are primarily used to verify the identity of the user is the same as that of the person to whom the data store was issued. In the present embodiment, the term ‘data store card’ is used to cover all types of portable data stores. In certain alternative embodiments discussed more thoroughly in the alternative embodiments section below, the data store may relate to a mobile telephone configured with a user profile information.

The system of FIG. 1 illustrates an example of how the IPT 3 of the present invention may be used to improve the security of a transaction occurring at a Point of Sale (PoS) 7 involving a portable data store. The PoS may relate for example, to a retail PoS, such as one might find in any retail store, also commonly referred to as Point of Purchase (PoP). The portable data store may relate to a data store card 9, such as a credit and/or debit card. At conventional points of sale, a terminal is provided (referred to as a PoS terminal), which requires the entry of a PIN to effect a transaction using a credit and/or debit card (as mentioned previously in relation to the discussion on EMV®).

In accordance with the present invention, the IPT terminal 3 may replace or supplement the PIN entry with a biometric authentication signal and/or electronic token, confirming the identity of the user as the authorized credit and/or debit card user. For the avoidance of confusion, it is to be noted that the terms ‘biometric authentication signal’ and ‘token’ will be used interchangeably, and the term token is effectively intended to be an electrical signal representing an authentication certificate, which confirms the user's identity. This biometric authentication signal is required to approve the transaction, and confirms to the card issuer that the authorized data store card user has initiated the selected transaction.

In the present embodiment, the authentication signal is generated locally at the IPT 3. A significant advantage of the present system in comparison to known PIN entry systems, is that it is significantly more robust and secure against fraud.

The user's data store card 9 (e.g., a credit and/or debit card), comprises a user profile 11 stored locally to the card. For example, the user profile may be stored in the non-volatile memory of an integrated circuit comprised in the card; in the magnetic stripe, if present; or in any other non-volatile storage means the card is provided with. For security purposes, the user profile 11 may be stored in encrypted form. The user profile data, comprises a biometric identifier suitable for uniquely identifying the user 5. The biometric identifier relates to one or more of the user's irises. For example, the biometric identifier may relate to an iris bit pattern generated from one or more of the user's irises. The iris bit pattern may be generated when the user creates an account with the issuer. Furthermore, since a user's iris does not change with time, the user's iris bit pattern may only need to be generated once for the lifetime of the user. The iris bit pattern is subsequently stored on the data sore card 9 in the user's profile data 11.

The generation of an iris bit pattern is fairly straightforward, and effectively comprises representing unique features of a user's iris pattern as a binary string. Accordingly, this binary string is a unique description of the iris, which is associated with a significantly smaller data size compared to the iris image. A process for generating an iris bit pattern is briefly described: Step 1) an image of the iris is captured under Near Infra-Red (NIR) illumination, once it has been verified that the presented eye is live, and other Quality Assurance (QA) checks have been passed; Step 2) the iris and the pupil are localized within the captured image, and QA checks are carried out to determine that the captured image meets any ISO requirements (for example, that the captured image resolution is sufficiently high); Step 3) the image of the iris is then converted to a binary bit string, referred to as an ‘IrisPrint.’

One way of generating the iris bit pattern, is to conduct an intensity profile analysis of the captured iris image. Each image pixel is subsequently converted to a binary number (i.e., a binary 0 or a binary 1) on the basis of its intensity value. Provided that the conversion convention used to generate the binary bit string from the intensity profile analysis of the captured image is confidential, then the original captured iris image cannot be obtained by reverse engineering the iris bit pattern (i.e., the bit string). In other words, the conversion convention used to generate the binary bit string from the captured iris image must remain confidential to maintain the integrity of IRT. The skilled reader will appreciate that while it may be desirable to represent every captured iris image pixel with a binary number, this is not a strict requirement. For example, it is possible to select, in accordance with a desired algorithm, the image pixels that are to be represented in the bit string. The precise convention used to generate the iris bit pattern is not relevant for the present invention, and it is envisaged that the present invention is compatible with any conversion convention.

Returning to the discussion of FIG. 1, the authentication signal is generated by first capturing an image of the user's 5 one or more irises with the IPT 3, which comprises an iris camera. An iris bit pattern is generated from the one or more captured iris images. The iris bit pattern is subsequently compared with the biometric identifier included in the user profile data 11 stored on the data store card 9. A positive authentication signal is generated on the basis of a positive validation result. Validation comprises comparing the generated iris bit pattern with the biometric identifier stored on the data store card 9. A positive validation result confirms that the generated iris bit pattern matches the biometric identifier stored on the data store card 9, and by deduction confirms that the user 5 wishing to carry out the requested transaction is the authorized card user.

Preferably, the authentication signal represents the result of the comparison between generated iris bit pattern and the biometric identifier stored on the data store card 9. In other words, the authentication signal preferably represents simply a ‘yes’ or ‘no’ confirmation of the comparison result. Subject to the authentication signal, the IPT 3 may proceed with executing the remaining transaction steps necessary to complete the requested transaction. For example, this might comprise executing the EMV® protocol steps required to finalise the transaction. This might comprise exchanging transaction data with an issuer bank server 17, via a shared communication network 15.

The validation may be carried out locally to the IPT 3, in which case the IPT is provided with processing means to carry out the comparison, or validation may be carried out remotely. In remote validation embodiments, some of the processing tasks of the IPT 3 may be outsourced to a computer 13, operatively connected to the IPT 3, or alternatively to a remotely located backend server (not shown)—though this is less preferable due to the increased time that would be taken to complete an authentication.

Both the local and remote validation embodiments are discussed in more detail below.

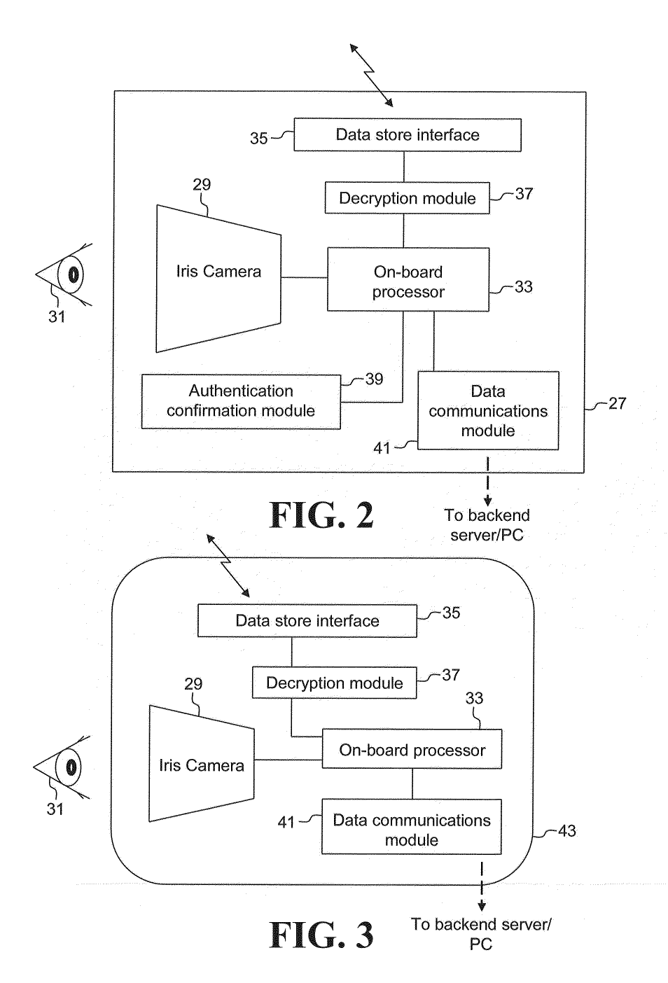

FIG. 2 is a schematic illustration of an IPT 27 suitable for carrying out local validation—i.e., the authentication token is generated local to the IPT 27. In such embodiments the IPT 27 comprises an iris camera 29 arranged to capture images of a user's eye 31; an on-board processor 33 configured at the very least to carry out image processing, in particular iris localization and iris bit pattern generation; a data store card interface 35, arranged to exchange data with the data store card 9; an optional decryption module 37, arranged to decrypt the user profile data 11 stored on the data store card 15; an authentication confirmation module 39, arranged to generate an authentication signal on the basis of a comparison of the generated iris bit pattern and the biometric data comprised in the user profile data 11; and a data communications module 41, arranged to enable communication with a backend server 17, or an operatively connected personal computer (PC) 13.

The data store card reader 35 may comprise a near field communication (NFC) transceiver to enable communication with an NFC enabled data store card. In this way, when the data store card 15 is brought into the vicinity of the IPT, the user profile data 11 is obtained, decrypted by the decryption module 37, and used for user verification purposes as previously described. In such embodiments, the data store interface is arranged to read data stored on the NFC data store card. However, and depending on the specific embodiment, the data store interface need not always be arranged to read data stored on the data store card. Specifically, this functionality will be determined by the type of data store the IPT is interacting with.

Where the data store relates to an Integrated Circuit Card (ICC), the IPT 27 may not be arranged to read data stored locally on the ICC. Rather, in such embodiments, the data store interface is arranged to power the ICC, to enable the ICC to carry out any required processing actions. Further details of this embodiment are set out below.

The IPT 27 of FIG. 2 is suitable as a stand-alone terminal. For example, the IPT 27 is suitable for use at any PoS, and in certain embodiments may provide a replacement for conventional debit and credit card PoS terminals. In such embodiments, the IPT 27 may further comprise conventional PoS terminal hardware modules, enabling the IPT 27 to carry out all the functionality of a conventional PoS terminal. For example, the IPT 27 may be provided with the hardware modules required to implement and execute the EMV® transaction protocol, and/or any other commonly used electronic payment transaction protocol. Accordingly, in such embodiments the IPT 27 may comprise a dock for receiving and powering an integrated circuit card (ICC), and/or a magnetic card reader for receiving and interfacing with a magnetic stripe data store card.

To confirm a transaction, an iris bit pattern is generated from a captured image of the user's eye 31. Validation is then carried out locally as previously described. The validation method will depend on the type of data store the IPT 27 is interfacing with. For example, where the data store is an ICC, for the purposes of maintaining the confidentiality of the user profile data stored locally in the ICC's non-volatile memory, the validation step may be carried out by the ICC. This may comprise the IPT 27 transmitting the generated iris bit pattern to the ICC for local verification with the user profile data (specifically with the biometric data included in the user profile). The ICC subsequently returns either a positive or a negative validation result, indicative of whether the generated iris bit pattern matches the biometric data stored locally on the ICC. The skilled reader will appreciate that in such embodiments the user profile data stored on the ICC is never physically transmitted to the IPT 27, thus maintaining its confidentiality. Furthermore, since at least a part of the validation step is outsourced to the ICC, the authentication confirmation module 39 is optional in such embodiments. The authentication signal may subsequently be transmitted to the on-board processor, or to the optional authentication confirmation module 39, where it is processed. If the authentication signal is indicative of a positive match having been made, the transaction may be completed by carrying out the remaining transaction protocol steps on the on-board processor 33 and with the data communications module 41. Similarly, if the authentication signal is indicative of a negative match, the transaction is terminated. The data communications module 41 may be used to upload the transaction details to a issuer and/or bank server 17 exactly in the same way as a conventional credit and/or debit card transaction.

The skilled reader will be familiar with known transaction protocols, such as the EMV® transaction protocol (i.e., Chip and PIN), and other conventional credit and debit card transaction protocols. For this reason, no further discussions of the protocols are provided. It is to be appreciated that the present invention may be used with any transaction protocol.

In embodiments where an NFC-enabled data store card is used with the IPT 27, the validation step (the comparison of the generated iris bit pattern and the biometric data included in the user profile data stored locally on the NFC card) may be carried out by the authentication confirmation module 39, which generates the authentication signal on the basis of the comparison result.

Alternatively, where the NFC-enabled data store is provided with a processor, the validation step may be carried out locally to the data store. In such embodiments, the NFC-enabled data store generates the authentication signal on the basis of the comparison result, when powered by an external electro-magnetic field provided by the IPT 27.

FIG. 3 is a schematic illustration of an IPT 43 arranged for remote validation, and comprises: an iris camera 29; a data store interface 35; an on-board processor 33; and a data communications module 41. The IPT 43 is substantially similar to the IPT 27 of FIG. 2, with the exception that it does not comprise an authentication confirmation module 39, and the validation step is not executed locally to the IPT. Rather, validation is outsourced to a remote, backend server or a PC. In certain embodiments the issuer bank server 17 may carry out the validation step. In which case, the issuer bank server is preferably provided with a database of registered user biometric data. Such a database would comprise pre-stored iris bit patterns of registered users.

For example, the generated iris bit pattern and the encrypted user profile data 11 obtained from the data store card 9, may be forwarded to the issuer bank server 17. Validation is carried out at the issuer bank server 17 by comparing the decrypted user profile data and the iris bit pattern. An authentication token is generated by the Issuer bank server 17, indicative of the comparison result. The authentication token is returned to the IPT 43, where it is processed by the on-board processor 33. If the received authentication token is indicative of a positive comparison result (i.e., the generated iris bit pattern matches the biometric data comprised in the encrypted user profile data 11), then the requested transaction is completed in the same manner as described previously. The transaction is refused in the event that the authentication token is indicative of a negative comparison result.

The IPT 43 may be provided with an optional decryption module 37, arranged to decrypt the user profile data 11 read from the data store card 15, for subsequent transmission to a remote entity for verification. For example, the verification may be outsourced to a connected PC 13, as illustrated in FIG. 1. The skilled reader will appreciate that out of security considerations it is preferable not to transmit a decrypted biometric identifier, such as comprised in the decrypted user profile data over wide area networks (WANs), or other types of long distance shared communication networks, to minimize the risk of data interception and/or eavesdropping. Accordingly, the present embodiment is preferably envisaged for, but not limited to uses where the validation step is outsourced to a connected PC 13, which although remote from the IPT 43, is operatively connected to the IPT 43 by a secure communication channel, or a point-to-point communication channel, such as a USB cable, where transmitted data cannot be intercepted by a third party. To enable the operatively connected PC 13 to carry out the verification step to determine if the decrypted user profile data 11 positively matches the generated iris bit pattern, the PC may be provided with a verification program. Clearly this embodiment makes the IPT 43 cheaper and simpler in construction to the IPT of the previous embodiment.

An alternative IPT embodiment may simply comprise a camera 29, a data store interface 35, and a data communications module 41 arranged to be operatively coupled to a PC 13. The data communications module may relate to a USB. In such an embodiment, the majority of the processing tasks are outsourced to the coupled PC. For example, the capture iris image is transmitted to the PC. All image processing, such as iris localization, and bit pattern generation is carried out on the PC. Accordingly, the PC is preferably provided with an image processing application arranged to carry out the aforementioned processing and bit pattern generation. In comparison to the other discussed embodiments, this embodiment is a lowest cost and simplest IPT solution. In part, this is due to the use of readily available components and the ease of implementation.

The skilled reader will appreciate that the decryption module 37 is only required in practical embodiments where the remote entity tasked with carrying out validation is not provided with the decrypting module for decrypting the user profile data 11. If the remote entity is provided with such an ability, the decryption module 37 in the IPT 43 is not necessary.

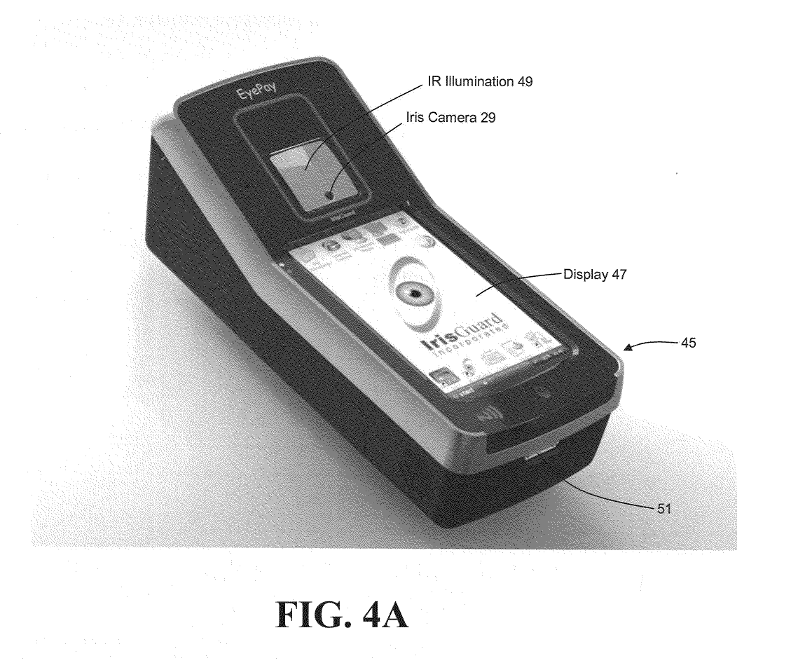

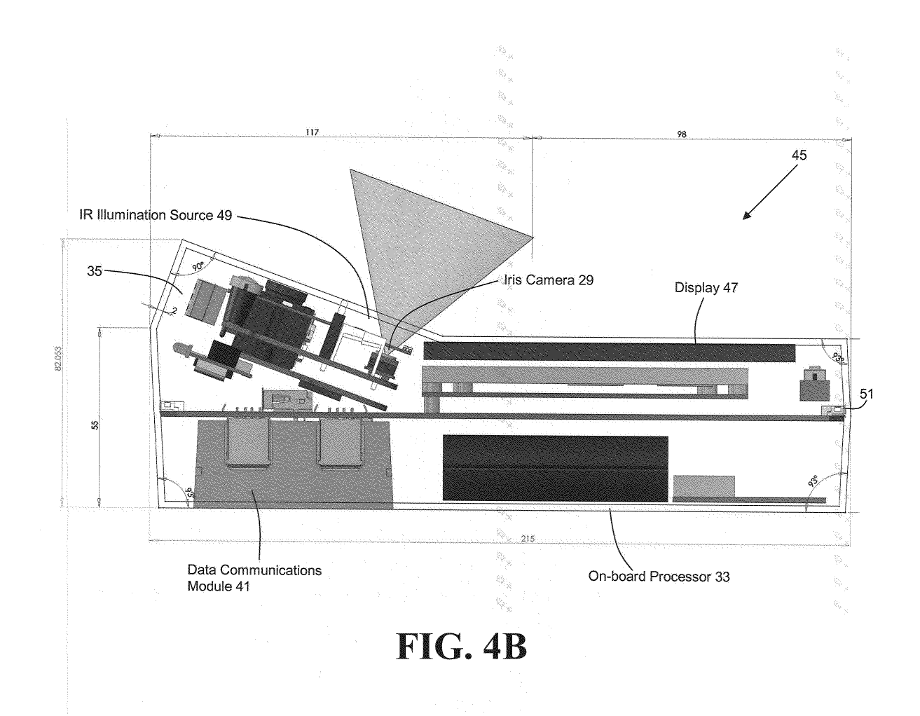

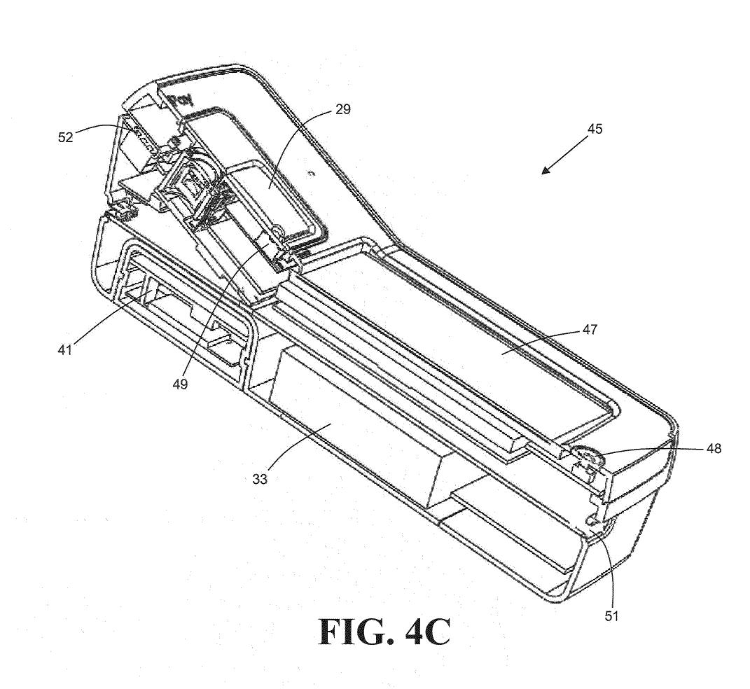

FIG. 4A is an image of a practical embodiment of any one of the earlier described portable iris authentication terminals, schematically illustrated in FIGS. 2 and/or 3. In addition to the modules illustrated in the schematic diagrams of FIGS. 2 and 3, the IPT 45 comprises a display unit 47 and an infra-red (IR) illumination source 49 arranged to illuminate the user's eye such that a sufficiently clear image of the iris may be captured. In the present embodiment, the data communications module comprises a USB (universal serial bus) port 51.

FIG. 4B is a longitudinal sectional view of the internal components of the IPT 45 of FIG. 4A. The data communications module 41 is readily viewable, along with the on-board processor 33. The data store interface 35 relates to an NFC interface in the present embodiment.

FIG. 4C is a perspective longitudinal sectional view taken from above, of an alternative embodiment of the IPT 45 of FIG. 4A, which comprises both a magnetic stripe card reader 52, and an NFC reader 48. The exact location of the data store interfaces, in other words the placement of the magnetic stripe card reader 52 and the NFC reader 48 are not important, and alternative placements are envisaged. The illustrated IPT is equipped to interface with both magnetic strip data store cards and NFC-enabled data store cards. Additionally, the IPT may be configured with an additional ICC data store card reader, such that all forms of data store card may be interfaced with.

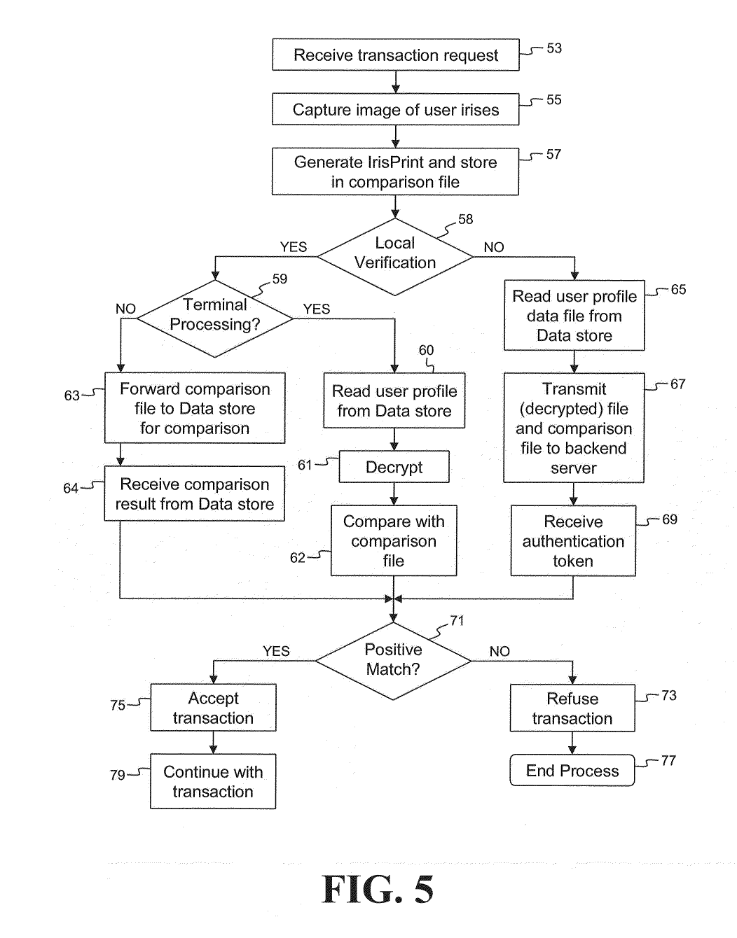

FIG. 5 is a process flow chart illustrating the method carried out by the iris portable terminals 3, 27, 43, 45 of the present embodiments. The method is initiated when the terminal 3, 27, 43, 45 receives a transaction request at step 54. The transaction request is received by the IPT's data communications module 41, 51. For example, this might occur at a PoS in a retail store, and the IPT 3, 27, 43, 45 may be operatively connected to a cash register via the data communications module 41. Alternatively, where the IPT doubles as a credit/debit card payment terminal (i.e., the IPT is provided with means for executing the required transaction protocol), the transaction request may be generated by the data store interface 35 upon detection of a data store card. For example, upon insertion of an ICC in the dock of the data store interface 35; or upon detection of an NFC card in the vicinity of the interface.

An image of one or more of the user's irises is captured at step 55. Preferably, the IPT comprises a display unit 47 such as illustrated in FIGS. 4a and 4b, to guide the user through the different steps required to execute the present method. The display unit is arranged to display instructions and/or progress updates to the user. For example, the display may indicate when the user is to position him/herself such that an image of the iris may be captured at step 55, and similarly when the data store card is to be provided to the terminal, or in the case of an NFC data store card when the card is to be brought into the vicinity of the terminal's NFC transceiver, such that step 59 may be executed. Conveniently, the display is a touch screen, which enables the user to input information to the IPT. An iris bit pattern, also known as an IrisPrint is generated from the captured iris image at step 57, and stored in a comparison file for later use during validation.

The IPT then queries whether local or remote verification is to take place at step 58. The answer to this query may be defined in the IPT's firmware, on the basis of the IPT's hardware. For example, an IPT having a hardware configuration of FIG. 2 may be configured in firmware to carry out local verification. Similarly, an IPT having a hardware configuration as illustrated in FIG. 3 is configured to carry out remote verification. Both embodiments are described in turn.

Where the IPT is configured to carry out local verification, the IPT must also determine at step 59 if the IPT processor 33/authentication confirmation module 39 carries out the verification step, or if the data store (for example, where the data store relates to an ICC) carries out the verification step. The type of verification may be determined on the basis of the detected data store type, by requesting that the user provide their data store card to the terminal, if it has not already been provided to the IPT in any one of the previous steps.

For example, where an NFC data store having no local processing means has been detected by bringing the NFC data store into the vicinity of the IPT, the on-board processor 33 and/or the authentication confirmation module 39 must execute the verification. The user profile data is read from the NFC data store at step 60, and may be stored in local memory for comparison purposes. If the user profile data is encrypted, the user profile data is decrypted at step 61, otherwise the IPT proceeds directly to step 62, where the user profile data is compared with the comparison file to generate an authentication token. The authentication token may be generated by either the on-board processor 33 or the authentication confirmation module 39. Decryption may be carried out by the decryption module 37.

In contrast, where an ICC data store is detected, by insertion of the data store into a powered dock comprised in the data store interface 35, or any other data store having local processing capabilities is detected, including an NFC data store having local processing capabilities, the verification may be carried out by the data store. The IPT forwards the comparison file to the data store for comparison with the user profile data stored on the data store, at step 63. An authentication token, providing the result of the comparison, is received by the IPT at step 64.

In both embodiments, the results of the comparison (i.e., the authentication token) are analyzed at step 71.

If a data store configured to carry out remote verification is detected at step 58, then the user profile data stored locally to the data store is read, at step 65. Where the user profile data file is encrypted, the IPT may optionally decrypt the data file if provided with a decryption module 37, prior to forwarding the user profile data along with the comparison file to the backend server, at step 67. Alternatively, the encrypted user profile data may be forwarded to the backend server along with the comparison file.

The comparison is carried out by the backend server, which might comprise the issuer bank server 17. The authentication token is generated by the backend server, and is received by the IPT at step 69, via a shared communication channel.

In all above described embodiments, the authentication token is analyzed at step 71 by the IPT, to determine if the executed comparison is indicative of a positive match between the user profile data 11 stored on the data store 9 and the comparison file including the generated iris bit pattern. This step may be carried out by the authentication confirmation module 39 if present, or by the on-board processor 33.

If a positive authentication result has been determined, the transaction is accepted at step 75 and the remaining outstanding transaction protocol steps are carried out in step 79 to conclude the transaction.

If instead a negative authentication result has been returned, the transaction is refused at step 73 and the process is ended at step 77.

### ALTERNATIVE EMBODIMENTS

The present IPT may be configured with one or more encryption modules arranged to encrypt any outgoing data. For example, the encryption module may be configured to encrypt all data that is transmitted to a remote device, such as the backend server, or a PC, for improved security.

Similarly, the IPT and the data store may both be configured with one or more secure cryptoprocessor chips, such that data exchanges between the IPT and the data store are encrypted. For example, when configured on the data store, the cryptoprocessor chip is used to store the user profile data in encrypted form in non-volatile memory local to the chip. Where validation is carried out locally to the data store, the IPT cryptoprocessor is used to encrypt the generated iris bit pattern, which is subsequently transmitted to the data store for validation. The cryptoprocessor chip local to the data store, decrypts the received iris bit pattern for subsequent comparison with the locally stored user profile data. The comparison operation is executed by the cryptoprocessor chip. This safeguards the confidentiality and security of the locally stored user profile data, since the user profile data is never transmitted in unencrypted form, and remains within the cryptoprocessor. In this way the user profile data cannot be obtained by eavesdropping.

The authentication token is also subsequently transferred from the data store to the IPT in encrypted form. The cryptoprocessors enable the IPT and data store to adopt significantly more complex encryption algorithms than would otherwise be used, due to the limited native processing capabilities of the data store and IPT. The skilled reader will appreciate that while it may be possible to crack an encrypted data transmission using a brute force attack, in practice the time required to successfully crack the encryption algorithm is too great, and cannot be achieved in the available time window available during a normal interaction cycle between the data store and the IPT. For present purposes, the interaction cycle may be defined as the series of steps required to carry out validation (e.g., steps 53 through 77 or 79, as illustrated in FIG. 5). It is envisaged that a normal interaction cycle between the data store and the IPT is of the order of several seconds at most, and preferably less. Furthermore, the IPT may be configured to timeout if the time latency between forwarding an encrypted data packet to the data store, and receipt of the response at the IPT is greater than a predetermined threshold value.

The cryptoprocessor chips also help to safeguard the IPT against hardware emulation via software. In other words, fraudulent acts where the IPT is deceived that it is interacting with a genuine data store, but instead third party software is being used to emulate the responses of a genuine data store. For example, by generating a false positive validation result to deceive the IPT into believing that the generated iris bit pattern matches the prestored user profile data. The presence of a cryptoprocessor chip within the IPT safeguards against such scenarios, due to the confidentiality of the employed cryptographic algorithms. A valid response from a genuine data store will be encrypted using the correct encryption algorithm. On receipt of data from the data store, the IPT is able to establish if the data has been encrypted with the correct encryption algorithm. Check sums, and hash values may be used, to name but a few, non-exclusive examples of the types of security checks that may be carried out by the IPT to determine if data received from the data store has been encrypted correctly. When instead the IPT deduces that the data has not been encrypted using the correct encryption algorithms, the IPT may conclude that it is interfacing with a fraudulent data store, and may terminate all interactions. In effect, the confidentiality of the encryption algorithms used by the cryptoprocessors, ensures that a fraudulent data store cannot emulate the encrypted responses of a genuine data store, and therefore may be used as a security feature by the IPT to ensure it is interfacing with a genuine data store.

Alternatively, an initial handshaking protocol may be carried out between the IPT and the data store, to enable the IPT to verify the authenticity of the data store. The handshake comprises exchanging encrypted data between the IPT, such that the IPT may determine if the data store is using the correct cryptographic algorithms. If use of the correct cryptographic algorithms is detected, then this indicates a genuine data store, and vice versa.

It is envisaged that the method of the present invention may be carried out by a PC, comprising an operatively connected camera and a data store card reader. The data store card reader and the camera may be connected via universal serial bus (USB) or any other commonly available data interface standard. In such embodiments, all the above described processing requirements carried out by the IPT are outsourced to the PC. For example, iris bit pattern generation is carried out by the PC on the basis of an iris image captured with the attached camera. Similarly, all data read from the data store card is processed by the PC. An advantage of the IPT of the present embodiment is its simplicity and, as a result, its relatively low cost.

Alternatively, and for ease of use especially for private home use, the IPT of the preceding paragraph may comprise local storage. In this way, a user may record their profile data, which comprises their iris bit pattern in the local storage. In such embodiments the data store is no longer required for the purposes of authenticating a transaction. Instead, the IPT accesses the locally stored profile data for comparison with the generated user bit pattern. Verification may then be carried out either locally at the IPT or remotely as described in relation to the preceding embodiments. Such an embodiment is envisaged for personal private use, where requiring that the user provide their data store to authenticate each desired transaction presents an inconvenience to the user.

In alternative embodiments, the authentication token may be concatenated to the transaction data, such as the data store card details, and may be forwarded from the IPT to the issuer bank server 17 for settlement. The issuer bank server 17 may comprise a database (not shown) featuring a list of all issued cards. Upon receipt of the transaction data and the authentication token, the card issuer server 17 is able to verify the authenticity of the card 9, by cross-referencing the card data with the database. The authentication token confirms that the user initiating the transaction is the genuine, authorized card holder. In this way, the security of data store card transactions is improved.

Alternatively, the issuer bank server database (not shown) may also comprise user biometric data associated with each issued card. In this way, upon receipt of the transaction data, the issuer bank server 17 is able to verify the validity of the authentication token. For example, the card issuer may perform a secondary comparison to verify that the user biometric data associated with the subject data store card and stored in the database, matches the generated iris bit pattern obtained from the IPT.

In yet further alternative embodiments where validation is carried out remotely from the IPT, an IrisPrint Verification Server (not shown) may be provided. The IrisPrint Verification Server comprises a database of all users' IrisPrints (i.e., a database comprising all users' iris bit patterns). During verification, both the generated iris bit pattern and the biometric information obtained from the user profile data 11, are forwarded to the IrisPrint Verification Server for comparison. The authentication token is then issued by the IrisPrint Verification Server in the same way as described previously in relation to the other remote validation embodiments.

Optionally, the IrisPrint Verification Server may also cross-reference the received iris bit pattern data with user data previously stored in its database. In such an embodiment, in addition to comparing the received generated iris bit pattern with the received user profile data, the generated iris bit pattern is also cross-referenced with the existing database of registered users' iris bit patterns. A valid authentication token is only generated where both the comparison and the cross-referencing step are positive. In other words, a valid authentication signal is only generated where the following two conditions are satisfied: 1) a positive match is established between the user profile data 11 and the iris bit pattern generated from the IPT; and 2) a positive match is established between the generated iris bit pattern, and a pre-existing user profile entry in the Verification Server database.

In yet a further alternative embodiment, a conventional mobile telephone comprising a camera may be used to carry out the present method. In other words, a mobile telephone may be configured to provide the functionality of the IPT. In such an embodiment, it is envisaged that the mobile telephone is configured with an application (i.e., software) enabling the telephone to carry out the method of the present invention. For example, it is envisaged that the application will enable the mobile telephone to generate an iris print pattern from a captured image of the user's eye, in addition to carry out the local and/or remote verification as required. The data store interface may comprise an ad-on hardware module, which may be operatively connected to the mobile telephone such that the user profile may be accessed from the data store. Alternatively, where the mobile telephone is provided with built-in NFC functionality, the ad-on hardware module may not be required where the data store also comprises NFC functionality.

As mentioned previously, in an alternative embodiment, an NFC-equipped mobile telephone configured with user profile data may be used to provide the functionality of the data store. In contrast to the preceding embodiment where an NFC-equipped mobile telephone comprising a camera is used to provide the functionality of the IPT, in the present embodiment an NFC-equipped mobile telephone configured with user profile data comprising a user iris bit pattern, is used to replace the functionality of the data store. This functionality may be provided via an application stored and executed locally to the mobile telephone. To initiate validation, the NFC-equipped mobile telephone is provided in the vicinity of the IPT, to thereby establish data communication between the IPT and the mobile telephone (i.e., the data store in this embodiment). Validation may occur either locally to the NFC-equipped mobile telephone, remotely on the IPT, or at a remote server as described in the preceding embodiments. The mobile telephone may be provided with an NFC chip which may be powered by the mobile telephone's internal power source (i.e., the battery of the mobile telephone), and/or by the electro-magnetic field of the IPT. For example, this embodiment could be used in conjunction with electronic purses such as Google Wallet™

In yet a further alternative embodiment, a camera-equipped mobile telephone may be configured with software to enable it to provide the functionality of both the IPT and the data store. For example, the mobile telephone may be provided with local storage for storing user profile data comprising a user's iris bit pattern. When authenticating a desired transaction, an iris bit pattern is generated of the user by capturing an image of the user's iris as mentioned previously in relation to preceding embodiments. This generated iris bit pattern is then compared by the mobile telephone with a previously stored iris bit pattern for authentication purposes. An authentication signal is generated and forwarded to a remote transaction server. This authentication signal may be concatenated to the transaction request data for approval by the issuer as previously described, and indicates whether the validation was successful or unsuccessful.

In certain embodiments the data interactions between the IPT and the data store may be programmed in the Java Card Open Platform (JCOP).

The IPT of the present invention may also be used in applications where the generation of a One Time Password (OTP) is required. For example, for online banking, where an OTP may be required to effect a financial transaction. Currently, online banking customers are provided with a plurality of Transaction Authentication Numbers (TANs). These are one time passwords used to authenticate a transaction, and are often simply provided in a confidential paper document, which must be kept safe by the user. Alternatively, users may be provided with an electronic number generator, such as Barclays PINsentry™, which generates the OTP when required to effect an online transaction. The IPT of the present invention provides an improved device for generating OTPs. The IPT may be configured with locally stored user profile data, as described in previous embodiments. To generate an OTP, the IPT captures an image of the user's iris, generates an iris bit pattern therefrom, for subsequent comparison with the locally stored user profile data as described in relation to preceding embodiments. An OTP is generated upon receipt by the IPT of a positive comparison result. While this embodiment is particularly useful for use in improving internet banking, it is equally useful in any application requiring the generation of an OTP. Furthermore, and since a biometric verification is carried out prior to generating any OTP, this embodiment helps to ensure that the OTP is generated only for use by the authorized user.

In embodiments where the IPT comprises a cryptoprocessor, the OTP may be generated by the cryptoprocessor upon receipt of an authentication token or signal, confirming a positive comparison result.

It is also to be appreciated that the present invention extends to methods of using a portable iris camera system, such as the herein described IPT, to effect a transaction and to improve the security of existing transaction authentication systems. Such a transaction may relate to a financial transaction and such authentication systems may relate to financial transaction authentication systems, such as financial transaction systems adopting the EMV® standard. Due to its compactness and portability, the IPT is suitable for both commercial and private use.

For example, in private use, the IPT may be used to authorize a credit/debit card transaction to effect an online payment over the internet or any other network. A positive validation of the user's iris is required to authorize the online transaction. This solution is significantly more robust than currently known solutions used to improve the security of online transactions, such as 3-D Secure™, which is also commonly referred to as Verified by Visa™, MasterCard SecureCode™, J/Secure™ or SafeKey™ by the different card issuers. 3-D Secure™ systems require the entry of a predefined user password to authorize an online transaction. This is usually input once all relevant credit/debit card payment details have been provided and is forwarded to the issuer for verification. However, such known systems still suffer from the same shortcomings inherent in any password-based security system. Furthermore, such password-based security systems do not provide an unequivocal confirmation that the authorized user is effecting the transaction. At best, such systems are able to provide a degree of comfort regarding the authenticity of the user, provided that the confidentiality of the password has been maintained. Password-based security systems are unable to provide any level of security against fraudulent transactions where the confidentiality of the password has been compromised.

The security of payment systems and other transaction authentication systems, is significantly improved by introducing an iris verification step in the authorization process. The iris-verification step provides a significantly greater level of security against fraudulent transactions, since its use provides a method of obtaining a greater degree of certainty regarding the authenticity of the user requesting the transaction. This is due to the inherent difficulties in forging an iris for the purpose of generating false-positive iris verification results. Additionally, the present method does not place any unnecessary demands on the user. For example, the user is not required to remember nor safeguard the confidentiality of any passwords or PINS.

The IPT described herein provides a convenient way of implementing an iris verification step in a transaction authentication system. Advantageously, the IPT may be retrospectively implemented in existing hardware infrastructures with little required amendment to the existing infrastructure. Similarly, the IPT provides an apparatus for improving the security of existing payment authentication systems at relatively little cost. For example, the IPT may be a self-contained unit comprising communication channels enabling it to be retrofitted to an existing payment terminal. Existing transaction protocols may require minimal modification to include the iris validation result in the authentication process. In this way, the IPT may be seamlessly integrated into known, existing payment systems.

The present embodiments are provided for illustrative purposes only, and are not limiting to the present invention. Furthermore, alternative embodiments are envisaged comprising any combination of features of the different embodiments described herein.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

What is claimed is:

1. A method of authenticating a transaction using a biometric identifier and a portable data store, the method comprising:
generating a first bit pattern of a user's iris from a captured image of the user's iris;
accessing a user profile stored on the portable data store, the user profile comprising a pre-stored second bit pattern of an authentic user's iris;
comparing the first and second bit patterns; and
generating an authentication signal to authenticate the transaction, when the first and second bit patterns are equivalent.

2. The method of claim 1, wherein the generating step comprises capturing an image of a user's iris and generating the first bit pattern from the captured image.

3. The method of claim 1, wherein the accessing step comprises obtaining the user profile from the portable data store.

4. The method of claim 3, wherein the user profile is encrypted and the accessing step comprises decrypting the user profile.

5. The method of claim 1, wherein the accessing step is carried out on a portable data store terminal.

6. The method of claim 5, wherein the comparing step and the authentication signal generating step are carried out local to the portable data store terminal.

7. The method of claim 5, wherein the comparing step and the authentication signal generating step are carried out remote to the portable data store terminal.

8. The method of claim 7, wherein the comparing step and the authentication generating step are carried out on the portable data store.

9. The method of claim 7, wherein the comparing step and the authentication signal generating step are carried out on a computer processor in operative communication with the portable data store terminal.

10. The method of claim 7, wherein the comparing step and the authentication signal generating step are carried out on a remotely located server in operative communication with the portable data store terminal.

11. The method of claim 7, further comprising:
receiving the authentication signal at the portable data store terminal and proceeding with the transaction.

12. The method of claim 5, wherein the generating step comprises capturing an image of a user's iris and generating the first bit pattern from the captured image, and the portable data store terminal comprises a camera arranged to capture an image of a user's iris.

13. The method of claim 1, further comprising:
generating a one-time password (OTP) in response to the generation of the authentication signal.

14. The method of claim 13, wherein the accessing step is carried out on a portable data store terminal, and the OTP is generated at the portable data store terminal.

15. A data store authentication terminal, for authenticating a transaction using a biometric identifier and a portable data store, the terminal comprising:
an iris pattern acquisition system for generating a first bit pattern of a user's iris from a captured image of the user's iris;
a data store interface for accessing a user profile stored on the portable data store, the user profile including a pre-stored second bit pattern of an authentic user's iris;
an authentication module configured to compare the first and second bit patterns, and generate an authorization signal to authenticate the transaction, when the first and second bit patterns are equivalent.

16. The terminal of claim 15, wherein the iris pattern acquisition system comprises an iris camera for capturing the image of the user's iris.

17. The terminal of claim 15, wherein the portable data store comprises an integrated circuit; the data store interface is arranged to power the integrated circuit; and the integrated circuit is configured to compare the first and second bit patterns and generate the authorization signal.

18. The terminal of claim 15, wherein the portable data store comprises a magnetic stripe, and the data store interface is arranged to access the user profile stored in the magnetic stripe.

19. The terminal of claim 15, wherein the portable data store is a near field communication device, and the terminal comprises a near field communication transceiver arranged to enable wireless data communication with the portable data store.

20. The terminal of claim 15, wherein the user profile is encrypted, and the terminal comprises means for decrypting the user profile.

21. The terminal of claim 15, wherein the terminal comprises data communication means for transmitting the authorization signal to a remote server to carry out a user requested transaction.

22. The terminal of claim 15, wherein the terminal comprises a one-time password generator configured to generate a one-time password (OTP) in response to the generation of the authorization signal.

23. The terminal of claim 22, wherein the one-time password generator comprises a cryptoprocessor configured to securely encrypt the OTP.

24. A data store authentication terminal, for authenticating a transaction using a biometric identifier and a portable data store, the terminal comprising:
an imaging system for capturing an image of a user's iris;
a data store interface for accessing a user profile stored on the portable data store;
a transmitter configured to transmit the captured image of the user's iris or information derived therefrom, and the user profile to a remote device for comparison;
a receiver for receiving an authorization signal representing a result of the comparison from the remote device; and
a processor arranged to enable the transaction to be carried out in the event of a positive comparison outcome result.

25. The terminal of claim 24, wherein the processor is arranged to generate a first iris bit pattern from the captured image, and the transmitter is configured to transmit the first iris bit pattern to the remote device.

26. The terminal of claim 25, wherein the user profile comprises a second iris bit pattern;
the transmitter is configured to transmit the second iris bit pattern to the remote device; and
the receiver is arranged to receive an authorization signal representing the result of the comparison between the first bit pattern and the second bit pattern.

27. The terminal of claim 25, wherein the data store comprises an integrated circuit, and the data store interface is arranged to power the integrated circuit; and the integrated circuit is configured to compare the first and second bit patterns.

28. The terminal of claim 25, wherein the portable data store comprises a magnetic stripe, and the data store interface is arranged to access the user profile stored in the magnetic stripe.

29. The terminal of claim 25, wherein the portable data store is a near field communication device, and the terminal comprises a near field communication transceiver arranged to enable wireless data communication with the data store.

30. The terminal of claim 25, wherein the user profile is encrypted, and the terminal comprises means for decrypting the user profile.

31. The terminal of claim 25, wherein the terminal is operatively connected to a personal computer (PC) via a shared data communication channel, and the transmitter is configured to transmit the captured iris image or information derived therefrom and the user profile to the PC for data comparison; and
the receiver is arranged to receive the authorization signal generated by the PC.

32. The terminal of claim 25, wherein the terminal is operatively connected to a remote server via a shared data communication channel, and the transmitter is configured to transmit the captured iris image or information derived therefrom and the user profile to the remote server for data comparison; and
the receiver is arranged to receive the authorization signal generated by the remote server.

33. The terminal of claim 24, wherein the terminal further comprises:
a one-time password generator configured to generate a one-time password (OTP) in response to receipt of the authorization signal.

34. The terminal of claim 33, wherein the one-time password generator comprises a cryptoprocessor configured to securely encrypt the OTP.

35. The terminal of claim 24, comprising a display for presenting the data comparison result to the user.

36. The terminal of claim 15, comprising a portable handheld terminal.

37. The terminal of claim 24, comprising a portable hand held terminal.

38. The terminal of claim 15, comprising a mobile telephone.

39. The terminal of claim 24, comprising a mobile telephone.

40. A data store authentication terminal, for authenticating a transaction using a biometric identifier, the terminal comprising:
an iris pattern acquisition system for generating a first bit pattern of a user's iris from a captured image of the user's iris;
a data store interface for accessing a user profile stored in a data store local to the terminal, the user profile including a pre-stored second bit pattern of an authentic user's iris;
an authentication module configured to compare the first and second bit patterns, and generate an authorization signal to authenticate the transaction, when the first and second bit patterns are equivalent.

41. The terminal of claim 40, further comprising:
a one-time password generator configured to generate a one-time password (OTP) in response to generation of the authorization signal.
